(19) United States
(12) Patent Application Publication
(10) Pub. No.: US 2017/0358842 A1
(43) Pub. Date: Dec. 14, 2017

(54) RAIL MOUNT STADIUM ANTENNA FOR WIRELESS MOBILE COMMUNICATIONS

(71) Applicant: Amphenol Antenna Solutions, Inc., Rockford, IL (US)

(72) Inventors: Joshua W. Shehan, Hickory, NC (US); Barry R. Wilson, Clinton, UT (US); Jasmin Davis, Sandy, UT (US)

(21) Appl. No.: 15/618,777

(22) Filed: Jun. 9, 2017

Related U.S. Application Data
(60) Provisional application No. 62/347,801, filed on Jun. 9, 2016.
(60) Provisional application No. 62/445,957, filed on Jan. 13, 2017.

(51) Int. Cl. H01Q 1/24; H01Q 1/44; H01Q 25/00; H01Q 1/42; H01Q 5/30; E04F 11/18

(52) U.S. Cl. CPC H01Q 1/241; H01Q 1/42; H01Q 5/30; H01Q 1/44; H01Q 25/001; E04F 11/18; E04F 2011/1868

(57) ABSTRACT

An antenna system has high capacity, continuous mobile coverage that is especially beneficial in stadium style venues. The use of a low profile, rail mounted antenna system and the abundance of hand and safety rails enable coverage throughout the venue. The system increases the density of communications antennas throughout the stadium providing significantly enhanced mobile voice and data service to a higher number of users over traditional stadium technology.

### RELATED APPLICATIONS

This application claims the benefit of U.S. Provisional Application No. 62/347,801, filed Jun. 9, 2016, and U.S. Provisional Application No. 62/445,957, filed Jan. 13, 2017. The entire contents of those applications are incorporated herein by reference.

### BACKGROUND OF THE INVENTION

### Field of the Invention

The present invention generally relates to antennas, and more specifically to cellular antennas for coverage in crowded, stadium style venues.

### Background of the Related Art

A key challenge for wireless communications service providers is maintaining quality of service in large, crowded environments where many wireless devices are simultaneously connected to the network. An example scenario is a stadium or arena where many fans may gather for a concert or a sporting event. In such environments, it is difficult to provide sufficient coverage and capacity to effectively accommodate all users.

From an RF standpoint, the optimal solution is a dense antenna deployment with many communications antennas distributed throughout the population of users. Unfortunately, the mounting and placement of such communications antennas can be considerably challenging. The layout and architecture of a stadium are carefully planned and executed to maintain a certain aesthetic particular to the venue. As a result, maintaining those aesthetics is important for communications devices such as antennas, and the antennas should seamlessly integrate into the venue ideally unnoticed. At the very least, antennas should integrate into the stadium in such a way that they do not obstruct the view of any attendee. Furthermore, the antennas should be placed such that they do not present safety hazards of their own where attendees may bump into or trip over the antenna causing injury.

To meet these requirements, current state of the art stadium antenna solutions for mobile wireless coverage generally involve mounting the antennas in areas above the intended crowd of users. In scenarios where there is an upper level that overhangs some portion of a lower level for example, the antennas may be mounted on the upper level to service the lower level. See Maslennikov et al., “Azimuth and Elevation Sectorization for the Stadium Environment,” Wireless Communications Symposium, Globecom 2013. Unfortunately, these approaches do not have the capability to meet the demands of the growing number of users transmitting and receiving more and more data. Therefore, an advance in the current state of the art is needed to meet the demands of the growing mobile wireless traffic in crowded, stadium style venues.

### SUMMARY OF THE INVENTION

A thin, hand rail mountable stadium antenna is provided to address shortcomings of traditional stadium antenna approaches. Since all arenas and stadiums are equipped with railing to enhance the safety of attendants, a rail mounted antenna presents an attractive solution for large, crowded venues. The antennas may be strategically distributed throughout the venue corresponding to locations of railing where the coverage and capacity can be met to provide attendees effective network connection. The rail mounting approach also provides a nice tradeoff between proximity to human contact and a dense network distributed throughout the population of users.

In an exemplary embodiment, the antenna may exhibit multiband operation covering low band and high band mobile wireless frequencies. The multiband embodiment enables coverage of multiple cellular bands for enhanced mobile service provided to attendants. The antenna may further comprise antennas of dual orthogonal polarization to maximize coverage throughout the venue. The high band antennas may be arranged such that the beamwidth is controlled for minimal overlap between neighboring sectors.

The antenna further includes a housing to provide mechanical support as well as a mounting vessel for the antenna. The housing is low profile and specifically shaped to fit stadium railing allowing seamless integration of the antenna into existing stadium architecture. As a result of the proposed mounting scheme, the atmosphere of the venue is maintained, and the antenna does not create an obstacle or distraction for attendees. Furthermore, no substantial stadium construction is required to provide a significantly enhanced mobile network with a dense deployment of communications antennas distributed throughout the venue. The term “stadium” and “venue” are used herein throughout this patent for ease of description to include any area having railings, such as indoor and outdoor stadiums, arenas, theatres, halls, with and without seating and/or stairs.

These and other objects of the invention, as well as many of the intended advantages thereof, will become more readily apparent when reference is made to the following description, taken in conjunction with the accompanying drawings.

### BRIEF DESCRIPTION OF THE FIGURES

FIGS. 1A-1E illustrate various deployment schemes with notional radiation beams for coverage within the venue;

FIGS. 2A-2C illustrate the dual band antenna structure;

FIGS. 3A-3D illustrate the high band element configuration, a detailed drawing of the HB elements;

FIGS. 3E-3L show typical radiation patterns in azimuth and elevation;

FIGS. 3M-3Q illustrate HB elements;

FIGS. 4A-4B illustrate a detailed drawing of the low band element along with typical radiation patterns in azimuth and elevation;

FIGS. 4C-4J show radiation beams in azimuth;

FIGS. 5A-5B illustrate the antenna housing and mounting approach for the proposed antenna system;

FIGS. 6A-6C illustrate a high band RF distribution network fully integrated into a HB feed board to which the dipoles are attached;

FIG. 7A is a perspective view of the HB array of FIGS. 6A-6C;

FIG. 7B is a top view of the HB array of FIGS. 6A-6C;

FIGS. 7C-7F are plots for the HB array of FIGS. 6A-6C, 7A-7B;

FIG. 8A is a perspective view of the LB element of FIG. 6C;

FIG. 8B is a side and exploded view of the LB element of FIG. 6C;

FIG. 8C is a perspective view of the top pipe of the low band antenna of FIG. 8A;

FIG. 8D is a perspective view of the sleeve connected to the top pipe of FIG. 8C, with the board removed;

FIG. 8E is a perspective view of the sleeve connected to the board, which in turn is connected to the top pipe;

FIGS. 8F-8G are a cut-away perspective views of the low band assembly of FIG. 8A;

FIGS. 8H-8K are plots for the LB element of FIGS. 8A-8G; and

FIGS. 9A, 9B are VSWR plots for the LB elements of FIGS. 8A-8G and the HB array of FIGS. 7A-7B.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in similar manner to accomplish a similar purpose. Several preferred embodiments of the invention are described for illustrative purposes, it being understood that the invention may be embodied in other forms not specifically shown in the drawings.

The present invention discloses a thin, handrail mountable antenna system designed to provide mobile wireless coverage in a stadium style venue. By mounting the antennas on handrails distributed throughout a venue, an advance in current state of the art stadium antennas is achieved. The density of handrails along with a novel mounting approach enables many antennas to be seamlessly integrated into existing stadium architecture. Thus a dense network with many communications antennas is created with minimal impact to the aesthetics of the venue, and the atmosphere of the venue is unaffected.

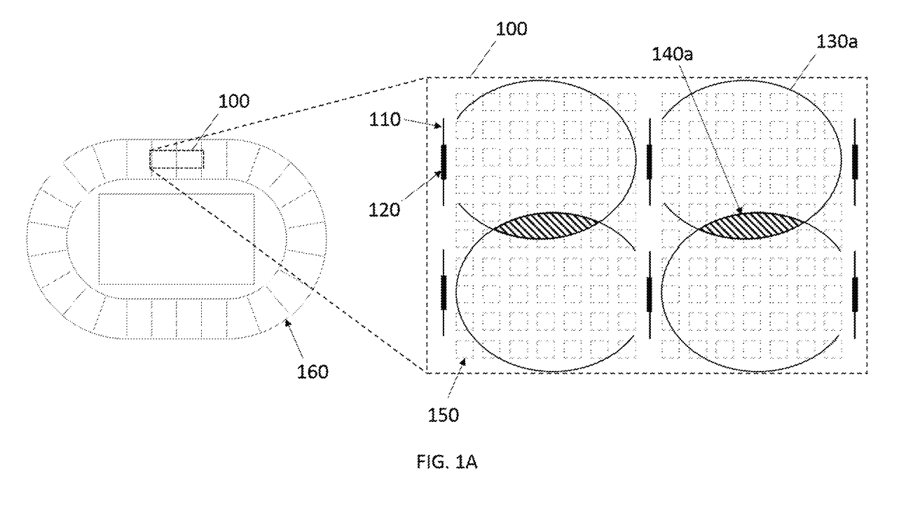

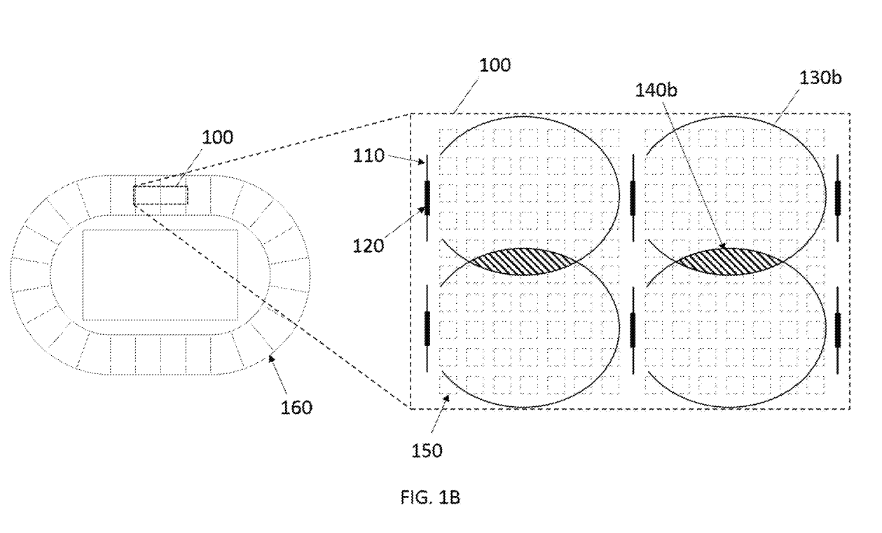

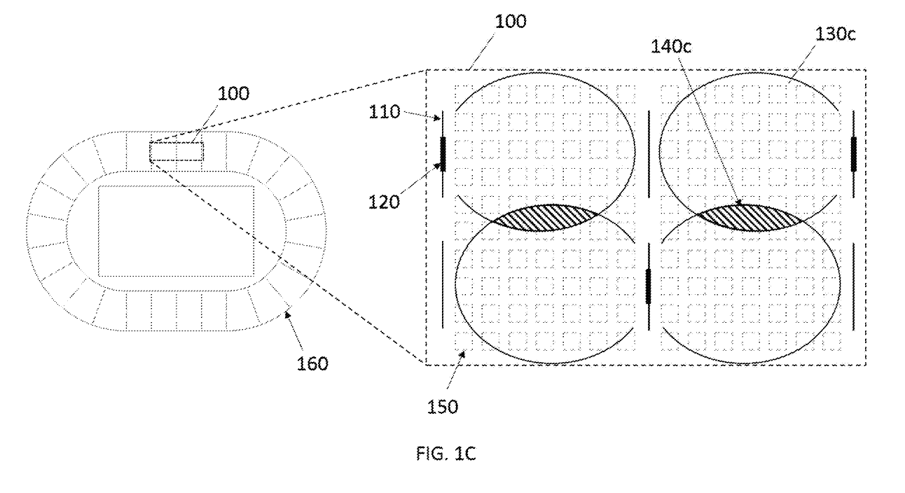

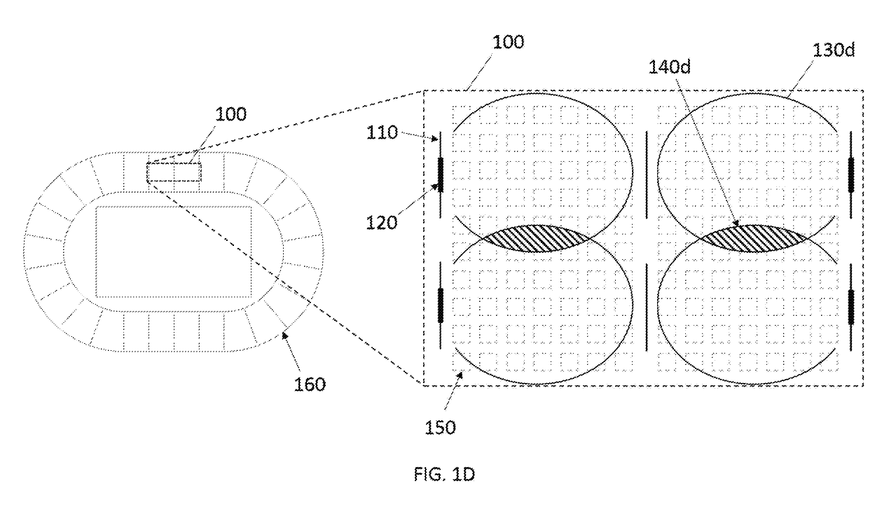

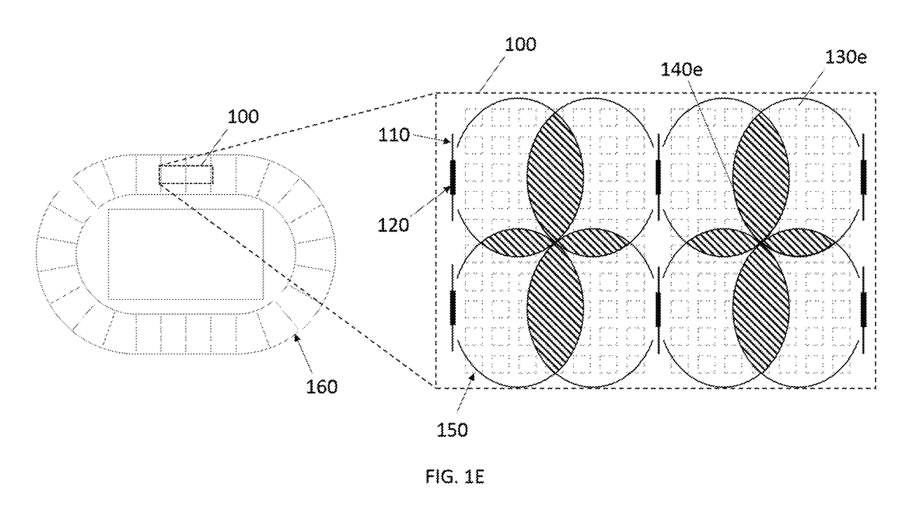

In FIGS. 1A-1E, aerial views of the distributed antenna system are shown for a typical stadium venue 160. Four exemplary coverage schemes are demonstrated using a subsection 100 of the stadium. Coverage scheme A with radiation beams 130a and beam overlap 140a is pictured in FIG. 1A, coverage scheme B with radiation beams 130b and beam overlap 140b is pictured in FIG. 1B, coverage scheme C with radiation beams 130c and beam overlap 140c is pictured in FIG. 1C, coverage scheme D with radiation beams 130d and beam overlap 140d is pictured in FIG. 1D, and coverage scheme E with radiation beams 130e and beam overlap 140e is pictured in FIG. 1E.

The stadium subsection 100 illustrates four sectors covered by radiation beams from the proposed rail mounted antenna assemblies 120. In the preferred embodiment, the antenna assemblies 120 are dual band antennas covering low band (LB) and high band (HB) frequencies of 690-960 MHz and 1695-2700 MHz, respectively, corresponding to carrier frequencies used to provide mobile wireless coverage. As illustrated by the exemplary subsection of the stadium 100, the antenna assemblies 120 are distributed throughout the stadium corresponding to locations of railing 110 between seating areas.

The distributed antenna system may use any coverage scheme illustrated in the non-limiting embodiments of FIGS. 1A-1E, and the antenna may use different coverage schemes for different bands of operation. In the preferred embodiment of a dual band antenna system with HB elements and LB elements, HB antennas use the coverage scheme in FIG. 1A while, at the same time, the LB antennas use the coverage scheme in FIG. 1E.

The antenna deployment may not be as dense as that shown in FIGS. 1A, 1B, 1E, where every section of railing 110 generally corresponds to an antenna mounting location. The deployment density is generally determined by the architecture and layout of the venue. Regardless of the deployment density, each network sector generally corresponds to a predetermined section of seats 150 within the venue where the majority of seats 150 within the sector are substantially covered by a single beam radiated from one side of the section. The beam overlap in each sector meets a predetermined maximum power level. The amount of beam overlap may be different depending on the chosen coverage scheme. Clearly, the coverage scheme A overlap 140a is significantly different than the coverage scheme E overlap 140e.

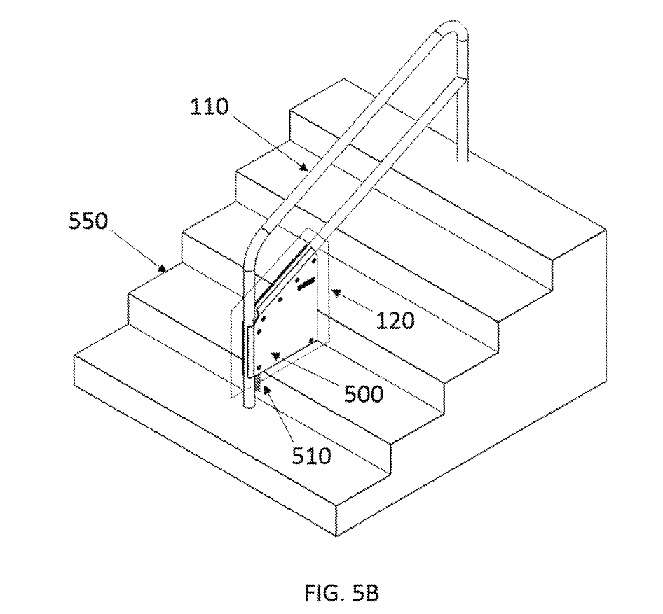

In FIGS. 1A-1E, the stadium subsection 100 has a two groups of rows m and columns n of seats 150. Each group is separated by an ingress/egress, such as an aisle, walkway or stairway. In the examples shown, the stairway is separated by one or more railing assemblies 110, with an upper railing and lower railing being shown for each stairway. The upper railing is aligned with an upper section of seats 150 in the group, and the lower railing is aligned with the lower section of seats 150 in the group. As best shown in FIG. 5B, the railings 110 extend upward from the stairs. The railing assemblies 110 have an elongated first vertical railing member at one end, an elongated second upright vertical railing member at an opposite end, and one or more elongated cross-railing members extending therebetween and connected to the first and second vertical railing members. The cross-railing members extend substantially parallel to the stairs or floor. If the floor is horizontal, than the cross-railings are horizontal. If the floor is angled, then the cross-railings are at the same angle. One or more vertical railings can be positioned between the two end vertical railings to further support the railing assembly. Each of the railing members can have a circular cross-section, or any other suitable shape.

An antenna assembly 120 is positioned on each railing 110, for instance centrally on the railing 110 to align with the respective seats 150. As further shown in FIG. 1A, the radiation beam 130a can extend to one side, namely to the right for the upper antenna and to the left for the lower antenna. Each section of seats 150 is substantially covered by a single radiation beam 130a with an area of overlap 140a between the upper and lower beams. For this configuration and all other described configurations, each section of seats 150 is generally covered by both HB and LB. The particular coverage configuration need not be the same for LB and HB, but it is generally desired to cover each section of seats 150 with both bands to enhance mobile coverage by the network.

In an alternative configuration, the radiation beam 130b may extend to one side, namely to the right, for all antennas as shown in FIG. 1B. In this configuration, each section of seats 150 is substantially covered by a single radiation beam 130b with an area of overlap 140b between the upper and lower beams.

In yet another alternative configuration of FIG. 1C, the radiation beam 130c may extend to both the left and right of each mounted antenna. For such a configuration, the upper section of seats 150 may be covered from the left/right where the lower section of seats is covered from the right/left. Each section of seats 150 is substantially covered by a single radiation beam 130c with an area of overlap 140c between the upper and lower beams. Because the radiation beams extend to both the left and right for each antenna, this configuration only requires an antenna at every other railing 110. Thus, one railing has an antenna, and each neighboring railing (both by column and by row) has no antenna. And, each railing without an antenna has neighboring railings (both by column and by row) that has an antenna. Thus, each railing with an antenna is surrounded on four sides by railings without antenna; and each railing without an antenna is surrounded on four sides by railings with an antenna. Each row and column has a pattern of railings as: antenna, no antenna, antenna, no antenna, etc.

In yet another alternative configuration of FIG. 1D, the radiation beam 130d may extend to both the left and right of each mounted antenna. For such a configuration, both the upper and lower section of seats 150 may be covered from the right or left. Each section of seats 150 is substantially covered by a single radiation beam 130d with an area of overlap 140d between the upper and lower beams. Here, the columns of railings 110 have a pattern of: all have antenna, none have antenna, all have antenna, none have antenna, etc. And the rows have a pattern within each row of: antenna, no antenna, antenna, no antenna, etc.

In yet another alternative configuration of FIG. 1E, the radiation beam 130e may extend to both the left and right of each mounted antenna. Each upper and lower section of seats 150 is partially covered from the left and right by two radiation beams 130e with areas of overlap 140e between the upper, lower, left, and right beams.

The particular beam configuration is generally dependent on the antenna type along with the performance required by the antenna system. For example, directional antennas could be used to provide coverage schemes A and B with enhanced network capacity over omnidirectional antennas that could be used to provide coverage schemes C, D, and E. Furthermore, the coverage schemes C and D may require fewer mounted antennas as indicated in FIGS. 1C and 1D. Coverage scheme E is essentially a combination of schemes C and D and may be used to enhance network capacity with omnidirectional antennas.

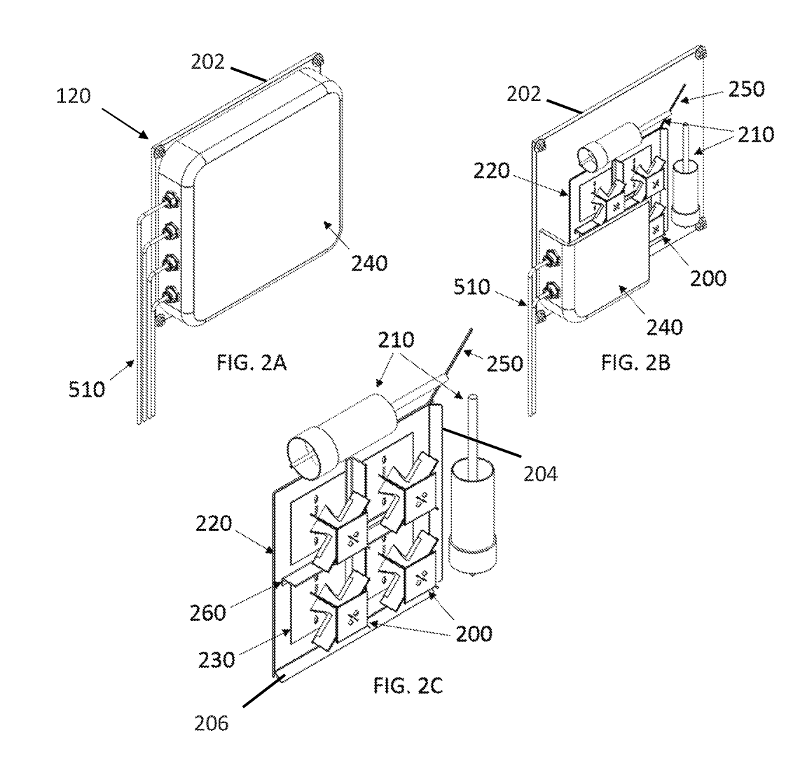

FIGS. 2A-2C show the detail of the antenna assembly 120 of FIG. 1. The antenna assembly 120 includes high band (HB) elements 200, low band (LB) elements 210, and radome 240. In FIG. 2A, the radome 240 and cables 510 are shown. The radome 240 is no more than 0.1 inches thick and generally composed of a material exhibiting a low loss tangent (tan δ≦0.01) and a low dielectric constant (∈ᵣ≦3.5). If an electrically thin radome is used, the dielectric constant may be higher than if the radome were electrically thick. In this case, electrically thin generally implies a thickness of λ/10 or less. As a rule, an electrically thick radome should be some multiple of λ/2 in order to minimize reflections from the radome. For the low band frequencies of the present invention, λ/2 is between 3.5-5 inches in free space leading to a very thick radome where losses could become problematic. Furthermore, the thickness does not remain close to a multiple of λ/2 over the full range of low band or high band frequencies leading to potentially significant reflections from the radome at various frequencies.

As a result, a thin radome is the most practical solution. There are many candidate materials available for the radome construction such as high impact polystyrene (HIPS), acrylonitrile butadiene styrene (ABS), polyetheretherketone (PEEK), and high density polyethylene (HDPE) to name a few. For the preferred embodiment, the HB radome 240 material is HIPS. The overall height of the radome is generally no more than 2.5 inches, enough to enclose the HB and LB elements with a small amount of margin.

For purposes of illustration, a portion (¾) of the radome 240 is cut away in FIG. 2B, and the radome is completely removed in FIG. 2C revealing the antenna elements underneath the radome 240. For dual band operation, four high band (HB) assemblies comprising eight HB elements 200 are used, together with two low band (LB) elements 210 are used. The frequency band for the HB elements 200 is 1695-2700 MHz, and the frequency band for the LB elements 210 is 690-960 MHz. In the preferred embodiment, the antenna is configured for simultaneous dual polarization in the HB configuration and in the LB configuration. The HB elements 200 are configured for dual slant ±45° polarization while the LB elements 210 are configured for vertical (V-pol) and horizontal (H-pol) polarizations. In either case, the two polarizations within each band should be orthogonal for maximum isolation between ports. The preferred embodiment is the dual band antenna, however, the antenna may also be configured for single band operation. The antenna can be configured to operate only in the HB frequency range of 1695-2700 MHz by removing the two LB elements 210 and only keeping the HB elements 200. Alternatively, the antenna may be configured to operate only in the LB frequency range of 690-960 MHz by removing the HB elements 200 and keeping only the LB elements 210.

As best shown in FIG. 2C, the antenna assembly 120 includes a backplane 202, feed board 230, high band elements 200, low band elements 210, HB ground plane 220, and isolation walls 260. The feed board 230 is connected to the HB ground plane 220, and the high band elements 200 are connected to the top surface of the feed board 230. The LB elements 210 and the HB ground plane 220 are connected to the backplane 202. The radome 240 extends over and the backplane 202 and radome 240 together completely surround the ground plane 220, feed board 230, high band elements 200, low band elements 210, and the isolation bar 250. The radome 240 and backplane 202 together form a housing to protect the antenna assembly from damage due to weather and passersby, and provide safety to passersby.

The ground plane 220 is connected to the backplane 202 using plastic standoffs. The ground plane 220 is a single continuous unitary thin plate, and can be centrally positioned with respect to the substrate 202. Both the backplane 202 and ground plane 220 can be substantially square-shaped, and the ground plane 220 is smaller than the backplane 202.

Each of the high band element assemblies are situated on a respective feed board 230, which in turn is connected to the ground plane 220. The feed board 230 can be square-shaped, and the high band elements 200 are placed in a square-shaped configuration on the ground plane 220, with a high band element assembly in the top right quadrant, top left quadrant, bottom right quadrant and bottom left quadrant of the ground plane 220. The low band elements 210 are positioned outside of the ground plane 220. As shown, one low band element 210 is positioned at the top side of the ground plane 220, and a second low band element 210 is positioned at and to the side (the right side in the embodiment of FIG. 2C) of the ground plane 220.

The isolation walls 260 are positioned between each of the HB elements 200. The isolation walls 260 project upward and outward from the top surface of the ground plane 220. The isolation walls 260 can be directly connected to the ground plane 220, such as by the isolation walls 260 being L-shaped with a short bottom member that is connected to the ground plane 220 by a connector or bonding (adhesive or solder), and an upright member that projects outwardly from the top surface of the ground plane 220. The isolation walls 260 are elongated members that extend substantially the entire length and width of the feed board 230. Thus, a first isolation wall 260 can extend the width of the feed board (shown horizontal in the embodiment of FIG. 2C), and a second isolation wall 260 can extend the height of the feed board (shown vertical in the embodiment of FIG. 2C). Each isolation wall 260 can be a single continuous unitary member.

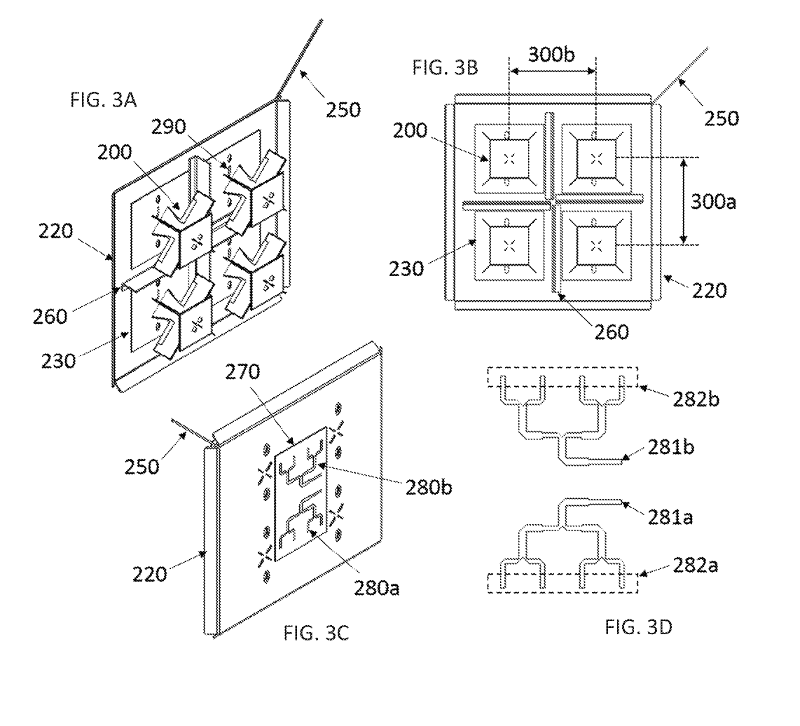

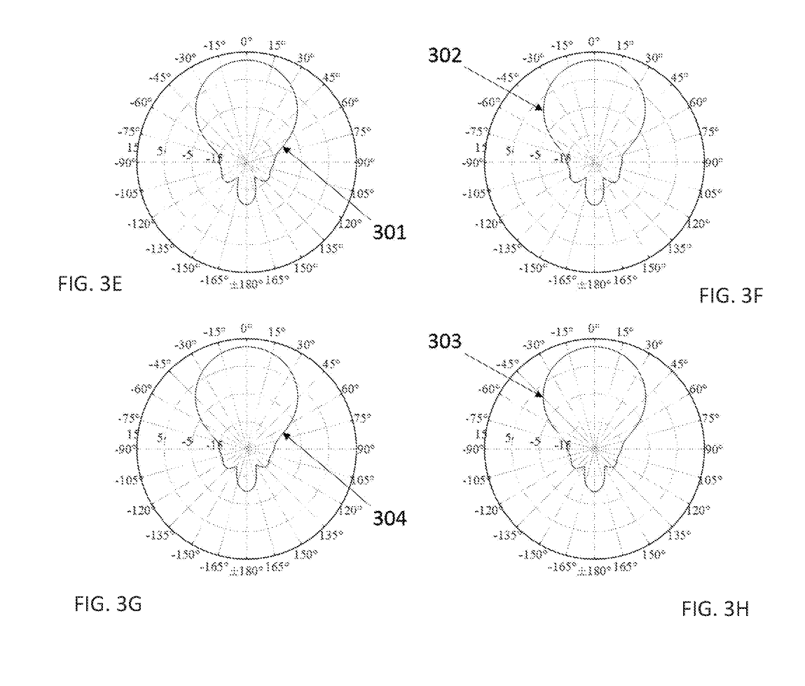

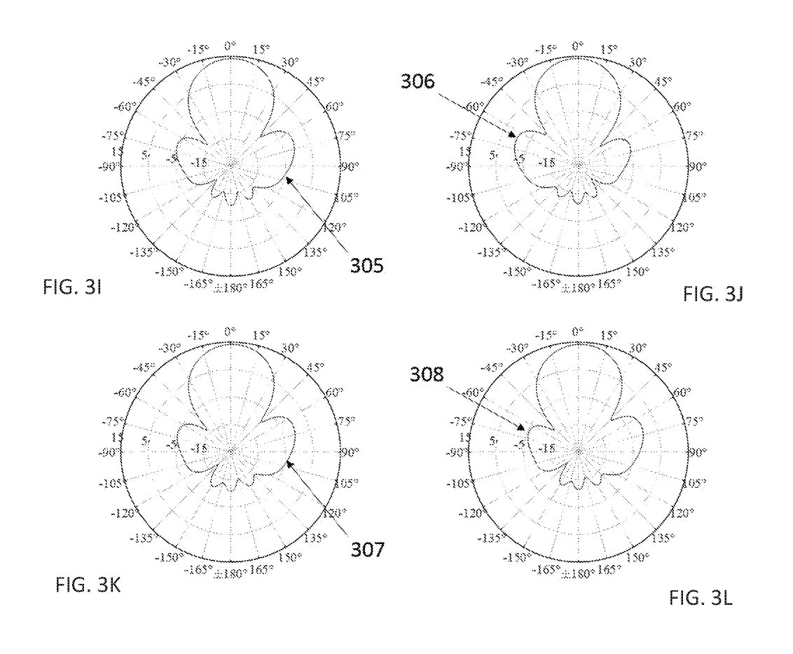

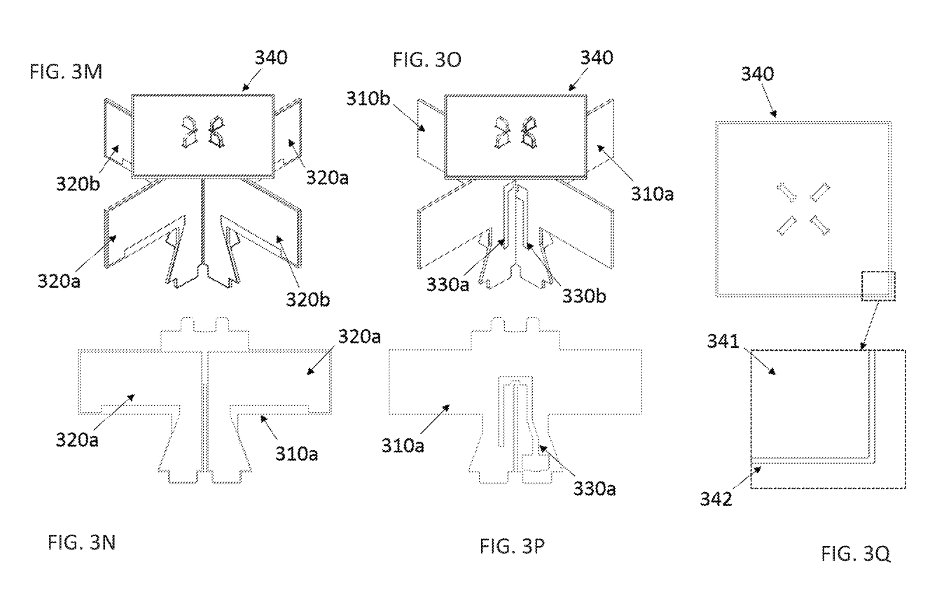

The isolation walls 260 serve to increase the electrical isolation between neighboring antennas 200 by grounding a portion of the signal that would otherwise couple to neighboring antennas 200. Thus, the diversity gain of the system is improved. The isolation walls 260 are in direct contact with the HB ground plane 220 to provide a ground path for signal that would otherwise couple between neighboring antenna elements. In one embodiment, the isolation walls 260 are bonded to the HB ground plane 220 using solder or conductive epoxy. In an alternative embodiment, the isolation walls 260 may be fixed to the HB ground plane 220 with mechanical fasteners. As best shown in FIG. 3B, the isolation walls 260 can be offset from one another in the vertical and horizontal directions. The upper vertical wall 260 is vertically offset from the bottom vertical isolation wall 260. And the left horizontal wall 260 is horizontally offset from the right horizontal wall 260. Alternatively, two isolation walls (one vertical and one horizontal) or a single isolation wall that includes vertical and horizontal members could be used to achieve the same effect. The use of four separate isolation walls simplifies assembly of the antenna with four identical pieces that are simply placed on the HB ground plane 220.

In one exemplary embodiment of the invention, the particular arrangement and element design of the HB elements 200 and the LB elements 210 are chosen, in part, to ensure that the antenna assembly 120 remains below a maximum thickness of two inches and fits within the prescribed volume indicated by the mounting position shown in FIG. 5B. Furthermore, the LB elements' 210 positioning relative to the HB ground plane 220 is multifold. The LB elements 210 are positioned to the side of the HB ground plane 220 firstly because this allows the LB radiation patterns to cover multiple sections of seats 150, enabling the LB elements 210 to comply with coverage schemes C, D, or E indicated in FIG. 1. The LB elements 210 are positioned to the side of the HB ground plane 220 secondly because this allows for easier manipulation of the input impedance to the LB elements 210. If the LB elements 210 were positioned substantially in front of the HB ground plane, establishing a good impedance match to the LB elements 210 over a broad bandwidth would be very difficult. The LB elements 210 are positioned to the side of the HB ground plane 220 thirdly because this does not block the radiation from the HB elements 200 and limits coupling between the LB elements 210 and HB elements 200.

The LB elements 210 may be moved in a manner parallel to the side of the HB ground plane 220. The LB elements 210 may also be moved closer to or further from the HB ground plane. Note that repositioning of the LB elements 210 may require slight modifications to the structure of the LB elements 210 for tuning purposes. Also, moving the LB elements very close to the HB ground plane 220 may require tuning of the HB elements 200 to account for their proximity to the LB elements 210. The LB elements 210 should be held in place with dielectric fasteners that may be mounted to the radome 240 or the HB ground plane 220. The particular arrangement of the HB elements 200 is chosen to maintain a desired beamwidth over the operating frequencies and provide directional radiation characteristics that comply with coverage schemes A or B as indicated in FIG. 1. The antenna includes two LB elements positioned as shown in FIG. 2 so that the antenna can provide multiple-input-multiple-output (MIMO) capabilities. For MIMO to work, two decorrelated antennas should be used. Decorrelation can be realized by spatially separating the two antennas or by using antennas in close proximity that are oriented at 90° with respect to each other. The LB arrangement here uses two antennas rotated 90° with respect to each other in addition to the isolation bar 250 to achieve decorrelation (or isolation) between the antennas.

In FIGS. 2B, 2C, the isolation bar 250 for the LB elements 210 is also shown. The isolation bar 250 is a thin elongated bar that is connected to one corner of the ground plane 220 (the top right corner in the embodiment shown). The isolation bar 250 extends outward at an angle to the ground plane 220, which is about 135° with respect to the left and right side edges of the ground plane 220 and also with respect to the top and bottom side edges of the ground plane 220. The isolation bar 250 reduces coupling between the two LB elements 210. The isolation bar 250 shorts a portion of the radiation that is polarized at +/−45° with respect to the two LB elements 210. Without the isolation bar, a portion of this signal is capable of being received by both antennas which results in coupling between the two LB elements 210.

The isolation bar 250 serves to reduce this coupling, which improves the isolation and diversity gain for low band operation. The isolation bar 250 is in physical contact with the ground plane 220 but does not touch the two LB elements 210 or the backplane 202. The isolation bar 250 is further positioned at an angle of 135° with respect to the two adjacent sides of the HB ground plane 220. The isolation bar 250 may be formed as part of the ground plane where the two are formed from a single piece of metal. Alternatively, the isolation bar 250 may be subsequently attached to the HB ground plane 220 by welding, solder, or epoxy. If the antenna is configured for high band operation only, there are no LB elements 210 and the isolation bar 250 is unnecessary and need not be included.

With respect to FIGS. 2 and 3, the eight HB antenna elements 200 are shown with notional radiation patterns. The eight HB elements 200 are realized as two electrically isolated dipole elements at each of four mounting locations. One dipole element is realized by the combination of 310a, 320a, and 330a while the other dipole element is realized by the combination of 310b, 320b, and 330b. Both elements share the tuning patch 340. The LB elements 210 are not shown in FIG. 3A only to clarify the arrangement of the HB elements 200. The LB elements 210 remain present in the preferred embodiment of the full antenna assembly 120. The HB elements 200 in FIG. 3A are crossed dipole antenna elements arranged to give dual slant polarization where there is a +45° polarized dipole, and a −45° polarized dipole. The HB elements 200 are positioned on what is referred to as the top side of the HB ground plane 220.

The electrical isolation between the +45° polarized dipole and the −45° polarized dipole should meet a minimum of 25 dB in the preferred embodiment. The two orthogonal polarizations are used to provide polarization diversity and enable multiple-input-multiple-output (MIMO) performance. MIMO operation and the benefits of MIMO are well-established in the mobile wireless field, and the crossed dipole is a common approach to achieve MIMO capabilities. Note that the use of orthogonal polarizations enable MIMO performance in a small package. Note that if the HB elements were oriented in the same direction so that their polarizations were non-orthogonal and the antennas were co-polarized, the elements would need to be spaced apart by some distance to achieve isolation between the ports. In this situation, the overall size of the antenna would increase as the required separation distance is usually multiple wavelengths. Furthermore, HB isolation structures may be needed increasing cost and complexity of the antenna. The two crossed elements are individually fed with baluns to provide the proper 0°/180° phase shift between the two dipole arms as those skilled in the art can appreciate. There are four mounting locations for each of the eight HB elements 200. In each mounting location, HB elements 200 are positioned where one of the elements is a +45° polarized dipole, and the other is a −45° polarized dipole. The four mounting locations for the HB elements 200 are separated by a distance 300a in azimuth and the same distance 300b in elevation to assist in providing a symmetric half power beamwidth (HPBW) of approximately 45° over the operating band. It is determined that the elements should be separated by a distance approximately equal to 0.75λ0-1.25λ₀ in order to provide the desired 45° HPBW over the range of operating frequencies.

To further control the HPBW, the HB ground plane 220 is configured to have beam shaping elongated walls 204, 206 that are positioned with an angle of 45° relative to the HB ground plane 220. The beam shaping walls 204, 206 are extensions of the HB ground plane 220 bent to the appropriate angle. The angle, height, and length of the beam shaping walls assist in providing the desired HPBW over the range of operating frequencies. Accordingly, the walls 204, 206 are integral with the ground plane 220 and are formed by bending two of the sides (top and bottom in the embodiment of FIG. 2C) an angle with respect to the rest of the ground plane 220. All four of the sides are bent (as best shown in FIGS. 3B, 3C), so that the walls 204, 206 project upward from the top surface of the ground plane 220 extending the entire height and width of the ground plane 220.

In one embodiment (FIGS. 3A-3D, 3M-3Q), the HB elements 200 are board-fed antennas where the baluns 330a, 330b feeding the dipole arms 320a, 320b are fed with microstrip feed traces 290 on the HB feed board 230. The HB feed boards 230 are mounted on the top side of the HB ground plane 220 same as the HB elements 200. The microstrip feed traces 290 are shown in FIG. 3A and in more detail in FIG. 3B where the HB elements 200 are removed for clarity. The microstrip feed traces 290 etched on a top side of double sided copper clad PCB board with a dielectric constant between ∈ᵣ=2-5 and a low loss tangent (tan δ≦0.02). In one embodiment, double sided copper clad Arlon 25N with a thickness of 0.03 inches is used as the PCB board material. The board material has a dielectric constant of approximately ∈ᵣ=3.28 and a loss tangent of approximately tan δ≦0.0025. The microstrip feed traces 290 of the HB feed board 230 are designed 50 Ohms and are connected to the baluns 330a, 330b using solder or conductive epoxy.

The RF distribution to the four dipoles of each polarization (+/−45°) is accomplished through the +45° HB power divider 280a and the −45° HB power divider 280b where the power dividers are configured to provide equal magnitude and phase to each of the dipoles. The power dividers 280a, 280b are mounted to the bottom side of the HB ground plane 220 as shown in FIG. 3C where the HB ground plane 220 is rotated 180° about its center compared to FIG. 3A. The power dividers 280a, 280b are formed in microstrip and are ideally etched on a top side of double sided copper clad PCB board with a dielectric constant between ∈ᵣ=2-5 and a low loss tangent (tan δ≦0.02). In one embodiment, double sided copper clad Arlon 25N with a thickness of 0.03 inches is used as the PCB board material. The bottom side of the PCB board is substantially covered in copper and serves as the ground plane for the traces of the HB power dividers 280a, 280b. The bottom side of the PCB board that is covered with copper is also in physical contact with the HB ground plane 220 and attached using solder or conductive epoxy for good electrical contact.

To feed the HB power dividers 280a, 280b, coaxial cables are attached at the input ports 281a, 281b where the center conductors of the cables are soldered to the traces, and the outer shield of the coaxial cables are attached such that it makes electrical contact with the ground plane on the bottom side of the board. This may be accomplished by etching a copper pad on the top side of the PCB board where vias are used to connect this pad to the ground plane on the bottom side of the PCB board. The outer shield of the coaxial cable is subsequently attached to this pad using solder or conductive epoxy to ground the outer shield of the coaxial cable. In a similar fashion, coaxial cables are attached at the output ports of the HB power dividers 282a/282b. The cables are then routed through holes in the HB ground plane 220 and attached in similar way to the microstrip feed traces 290 on the HB feed boards 230. The coaxial cables should be phase matched to within ±5° to ensure that all antennas are fed with equal amplitude and phase for a given polarization.

FIGS. 3E-311 illustrate typical free space radiation beams in azimuth for +45° slant polarization 301 and −45° slant polarization 302 along with the elevation beams for +45° slant polarization 303 and −45° slant polarization 304 at 1700 MHz. FIGS. 3I-3L illustrate typical free space radiation beams in azimuth for +45° slant polarization 305 and −45° slant polarization 306 along with the elevation beams for +45° slant polarization 307 and −45° slant polarization 308 at 2700 MHz.

The radiation beams are shown for operation in free space and represent an ideal case for radiation from the HB elements 200. In the operating environment, the radiation beams will differ from what is shown due to scattering from nearby objects. In this case, azimuth and elevation are defined with respect to the venue where the azimuth plane corresponds to the plane parallel to the field level or the ground floor of the venue, and the elevation plane corresponds to the plane orthogonal to the field level or ground floor of the venue.

The directional nature of the HB antenna configuration in the preferred embodiment makes it suitable for coverage schemes A or B with respect to FIG. 1. These coverage schemes utilize antennas that are directional in nature to cover only a single section of seating 150 whereas coverage schemes C, D, and E utilize omnidirectional antennas to at least partially cover multiple sections of seating 150 simultaneously. The present HB configuration could be arranged for coverage schemes C, D, or E by positioning two sets of antennas back to back. However, this requires the thickness of the antenna assembly 120 to double which is generally undesirable.

The present invention is not limited to dipole antenna elements for the high band elements. Any style of radiating element may be used as deemed appropriate. The crossed dipole is used in the preferred embodiment due to the ability to achieve broad band, dual linear operation with a simple feeding arrangement in a somewhat compact size. As an alternative example, patch antennas provide a low profile antenna element and may be a suitable alternative to the crossed dipole element. Furthermore, the antennas may be configured to give other polarizations such as single linear polarization with vertical, horizontal, or slant orientation. The dual linear configuration could also be configured for simultaneous vertical and horizontal polarization. The number of HB elements, the HB element spacing, and the configuration of beam shaping walls could also be modified for a HPBW other than the 45° HPBW of the preferred embodiment. For example, three HB elements could be used to give a radiation pattern that is more triangular in shape. Note that the use of other antenna elements or arrangements may require a different configuration of isolation walls or eliminate their need altogether.

With respect to FIGS. 3M-3Q, the HB elements 200 are fabricated in a similar manner to the RF feed board 230. The elements 200 are fabricated using 0.03 inch thick double sided clad Arlon 25N which forms the −45° element substrate 310a and the +45° element substrate 310b. The dipole arms 320a, 320b are etched or milled on one side of the element substrate 310a, 310b and the baluns 330a, 330b are etched on the opposite side. This is illustrated in FIG. 3M showing a front view of the HB element 200 and FIG. 30 showing a back view of the HB element 200. As those skilled in the art can appreciate, the baluns 330a, 330b do not make physical contact with the dipole arms 320a, 320b, but they are electrically coupled to feed the antenna and provide the proper phasing for the element 200. The elements 200 are further fabricated with dipole mounting tabs on the bottom of the dipole arms 320a, 320b that feed through the RF feed network 230 PCB. The metallization for the dipole mounting tabs is in physical contact with the dipole arms 320a, 320b and is soldered to the ground plane of the RF feed network 230 securing the antenna elements 200 in place.

The elements 200 further have a tuning patch 340 secured on top of the dipole arms 320a, 320b to help with tuning and isolation between the orthogonal polarizations. The tuning patch 340 is fabricated in the same manner as the dipole arms 320a, 320b and RF feed network 230 where Arlon 25N is used as the tuning patch substrate 342. The tuning patch only contains metallization on the top side of the tuning patch substrate 342. To secure the tuning patch 340 in place, patch mounting tabs are fabricated on the element substrates 310a, 310b. The patch mounting tabs are metallized, but the metallization does not make physical contact with the metallization for the dipole arms 320a, 320b. The tuning patch metallization 341 is soldered to the metallization for the patch mounting tabs to secure the tuning patch 340.

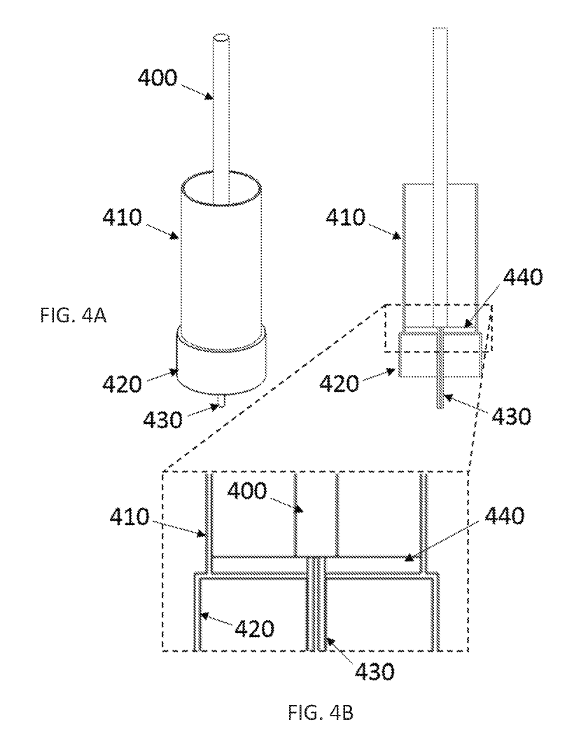

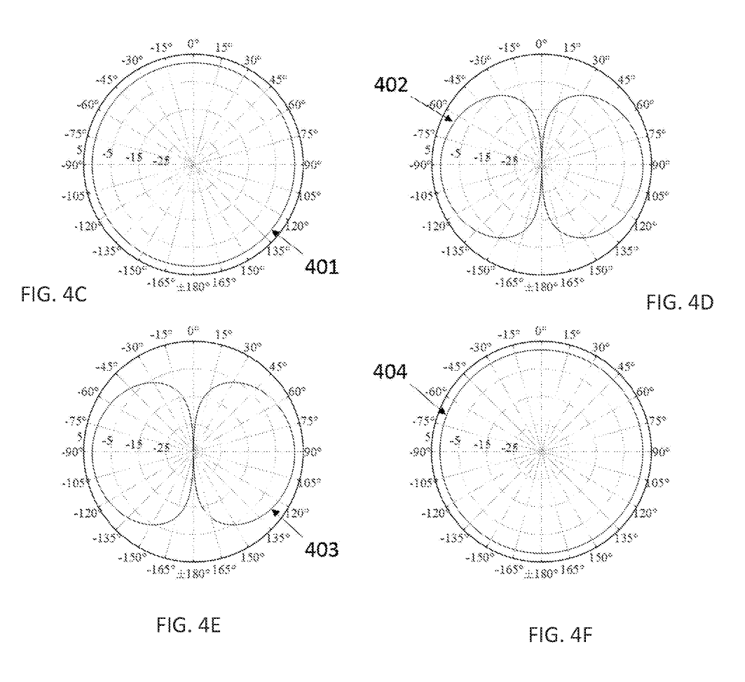

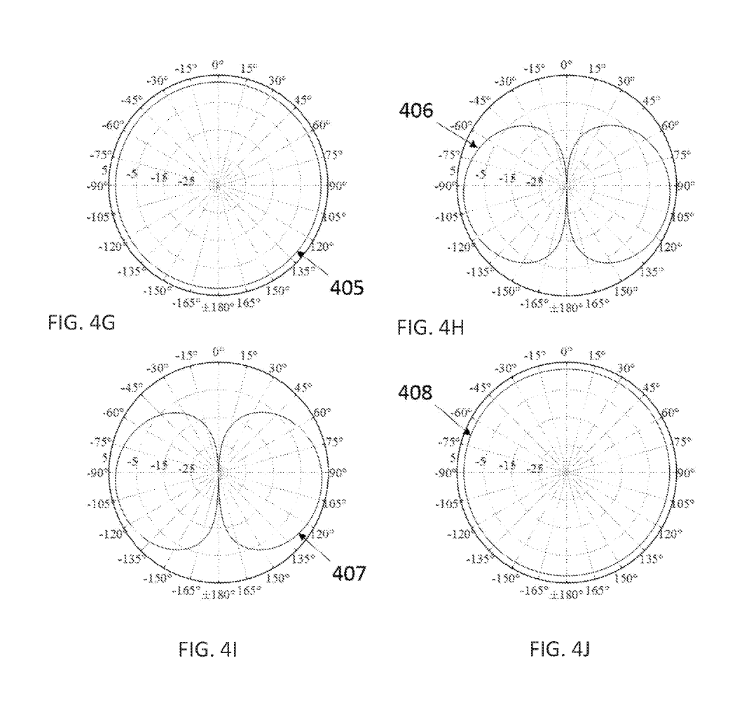

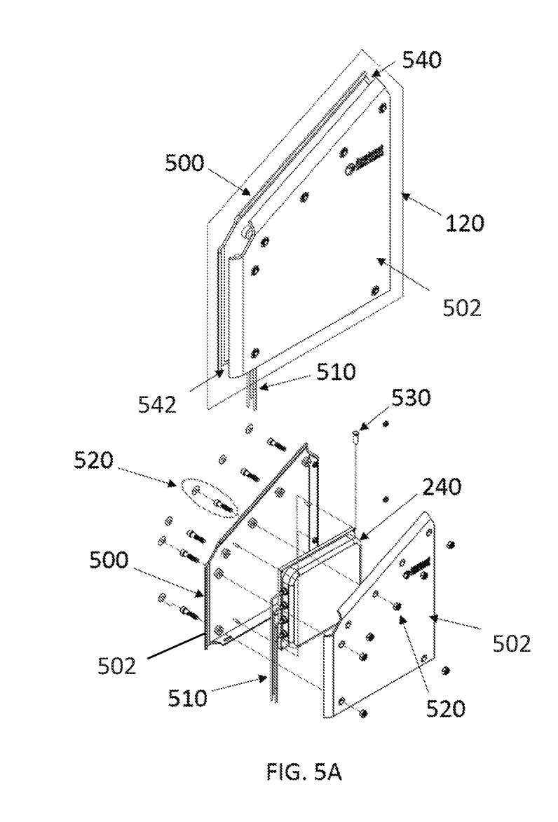

In one embodiment, the LB elements 210 are sleeve monopole antennas as shown in FIGS. 4A, 4B. The antennas consist of a central radiating element 400, an upper tubular sleeve 410 that surrounds a lower portion of the central radiating element 400, and a lower tubular sleeve 420 that extends opposite to the central radiating element 400. The antenna further includes a dielectric spacer 440 that maintains the distance between the central radiating element 400 and the junction of the upper 410 and lower 420 tubular sleeves. The distance between the central radiating element 400 and the junction of the upper 410 and lower 420 tubular sleeves is used to tune the input impedance to the antenna. By properly choosing the height of the dielectric spacer 440, a broadband impedance match is obtained. The entire dielectric spacer 440 fits fully inside of the upper tubular sleeve 410. A dielectric spacer 440 with a low dielectric constant (∈ᵣ≦5) and loss tangent (tan δ≦0.02) works well. The dielectric constant along with the height of the dielectric spacer 440 provides broadband tuning capability for the antenna.

In one embodiment, the dielectric spacer 440 is made of 0.1 inch thick Delrin with a dielectric constant of approximately ∈ᵣ=3.7 and a loss tangent of approximately tan δ=0.005. In an alternative configuration, the dielectric spacer 440 could be made of laminated PCB material using a suitable prepreg. However, this is generally a much more costly approach and can be impractical for some embodiments.

The antenna is fed with a coaxial cable 430 where the center conductor and dielectric insulation of the cable are fed through a hole at or near the center the dielectric spacer 440 and make contact with the central radiating element 400. The center conductor of the coaxial cable 430 is in electrical contact with the central radiating element 400 and is attached using solder or conductive epoxy. The outer shield of the coaxial cable 430 is in electrical contact with the lower tubular sleeve 420 and is attached using solder or conductive epoxy. The vertical and horizontal polarized LB elements 210 may contain subtle differences for tuning purposes but are substantially similar in design and fabrication. The antennas may further include a dielectric material that fills a portion of or the entire space between the upper tubular sleeve 410 and the central radiating element 400, as more fully described in co-pending application Ser. No. 15/395,170 filed Dec. 30, 2016, which is a continuation-in-part of application Ser. No. 15/350,984 filed Nov. 14, 2016, entitled Sleeve Monopole Antenna with Spatially Variable Dielectric Loading, the entire contents of both of which are hereby incorporated by reference. The dielectric material is generally used to help tune the antenna in its operating environment, for example, taking into account the proximity of the antenna to attendees at the venue.

The present invention is not limited to sleeve monopole antenna elements for the low band elements. Any style of radiating element may be used as deemed appropriate. The sleeve monopole is used in the preferred embodiment due to the ability to tune the antenna in its operating environment. As an alternative example, a biconical style dipole antenna may provide a suitable alternative giving relatively broad impedance bandwidth and similar radiation patterns to the sleeve monopole.

FIGS. 4C-4F illustrate typical free space radiation beams in azimuth for vertical polarization 401 and horizontal polarization 402 along with the elevation beams for vertical polarization 403 and horizontal polarization 404 at 690 MHz. FIGS. 4G-4J illustrate typical free space radiation beams in azimuth for vertical polarization 405 and horizontal polarization 406 along with the elevation beams for vertical polarization 407 and horizontal polarization 408 at 960 MHz. The radiation beams are shown for operation in free space and represent an ideal case for radiation from the LB elements 210. In the operating environment, the radiation beams will differ from what is shown due to scattering from nearby objects. In this case, azimuth and elevation are defined with respect to the venue where the azimuth plane corresponds to the plane parallel to the field level or the ground floor of the venue, and the elevation plane corresponds to the plane orthogonal to the field level or ground floor of the venue. Unlike the high band configuration, the low band configuration gives a radiation beam that is the result of a single omnidirectional antenna. Therefore, the low band configuration in the preferred embodiment gives rise to radiation patterns that are suited for coverage schemes C, D, or E with respect to FIG. 1 due to the omnidirectional nature of the antennas.

With respect to FIG. 5, the antenna housing 500 is pictured along with the proposed mounting approach for the present invention. FIG. 5A illustrates the full antenna assembly 120 along with the housing structure 500, radome 240, cables 510, and mounting hardware 520. As shown in FIGS. 5A, 5B, the housing 500 can be formed by two separate thin plates 502 having a shape that matches at least part of the stadium railing 110. Thus, the top edge of the housing 500 can be at an obtuse angle with respect to the front edge of the housing 500, and can be 135° to accommodate the rise angle of the stairs. The top edge of the housing 500 is at the top outer periphery of the housing 500, and the front edge of the housing 500 is at the front outer periphery of the housing 500. The two plates 520 each have a peripheral edge that is bent to curve inward so that the two plates 520 can come together and have an interior space that houses the radome 240 and can substantially completely surrounds the radome 240. The plates 502 protect the radome 240 from passersby and connect to a railing.

In the illustrated non-limiting example of FIGS. 5A, 5B, the top edge of the housing 500 aligns with the cross-member bar of the railing, so that a top groove 540 can receive and engage the cross-member bar of the railing. And the front side edge of the housing 500 aligns with the front vertical bar of the railing 110, so that a front groove 542 can receive and engage the vertical bar of the railing. Having the grooves 540, 542 at the outer edges of the periphery of the housing 500 maximizes the interior space available to retain the antenna assembly. A notch can be formed at the corner where the top groove 540 and front groove 542 come together, to accommodate the railing. The grooves 540, 542 can be formed (for instance) by bending the outer peripheral edges of the housing 500 inward slightly.

The entire housing 500 (including the antenna assembly 120) is the same thickness as, thinner than, or slightly larger than the railing and flat so that it does not obstruct attendees that pass by. As best shown in FIG. 5B, the housing 500 can extend all the way down to the stairs 550, so that it abuts (and/or can be coupled to by fastener(s) and/or mounting features) the top horizontal surface and rising vertical surface of a stair. Thus, the housing 500 connects to the vertical railing and the cross-railing. Accordingly, the housing 500 is positioned at one of the vertical railings, which is at one end of the railing assembly (or can be between the two vertical end railings), so that the housing 500 is at the least obstructive location on the railing assembly. In this manner, the housing 500 is firmly attached to the railings and cannot rotate with respect to either the vertical railing or the cross-railing. In addition, where there are several cross-railing members, the housing 500 is coupled to the lower cross-railing member.

The housing structure 500 is fabricated from a durable, lightweight plastic material in order to protect the internal electronics from damage. The material further exhibits low dielectric constant (∈ᵣ≦3.5) and low dielectric loss tangent (tan δ≦0.01). In the preferred embodiment, the antenna housing is made of the same HIPS material as the radome. As with the radome, alternative materials are available for the antenna housing. The final material selection is determined based on cost and fabrication complexity vs desired performance.

The mounting hardware 520 is used to secure the two pieces of the housing 500 in place and ensure the antenna assembly 120 is securely attached to the railing 110. The antenna assembly 120 is sandwiched between the two plates 502 of the housing 500, so that it is protected and does not come into direct contact with attendees. For the preferred embodiment, the mounting hardware is stainless steel although, alternative materials such as aluminum may be used. The grooves 540, 542 in the housing 500 are sized corresponding to the railing to which the antenna assembly 120 is attached. The cables 510 are coaxial transmission lines and route RF signal between the antenna(s) and base station(s) within the stadium. The number of cables 510 corresponds to the number of polarizations and number of frequency bands where each cable feeds a specific polarization within a specific frequency band. For the preferred embodiment, there are two polarizations for each of two frequency bands giving a total of four cables 510 feeding the antenna assembly 120. The cable 510 extend from the interior of the housing 500 between the two plates 502, to the exterior of the housing 500. For instance, the plates 502 can have an opening at the bottom (for example, at the front groove 542), and the cables 510 can extend through the opening.

The antenna assembly 120 is shown in its intended mounting location in FIG. 5B. As opposed to stadium antenna approaches where the antenna is mounted within seating areas beneath or fixed to spectator seats, the stadium railing 110 along with the stadium steps 550 offer mounting support for the antenna assembly 120 that maximizes coverage to a particular seating area while minimizing human interaction that could detune the antenna or cause radiation safety concerns. Furthermore, the intended mounting approach provides increased coverage with reduced power levels compared to stadium antenna solutions that mount antennas overhead requiring higher power to fully cover lower levels of seating.

The plastic housing 500 is the only part of the antenna assembly 120 visible from the outside and is the only part observable by attendants at a given venue. The antenna housing can also be painted with the service provider logo or even a logo representing the team that competes at a given stadium. Therefore, the aesthetics of the venue are maintained. As shown, the antenna assembly 120 can be positioned at a lower portion of the railing 110 and toward the bottom (front) part of the railing, where it is least likely to visually or physically obstruct attendees. As safety rails generally call attention in their own right, the antenna does not create any kind of hazard in its mounting location. The overall antenna can be less than 3 inches thick, so the entire housing 500 is minimally intrusive and fits within the width of the railing assembly.

Furthermore, positioning at the front of the railing provides some protection for the cabling 510 of the antenna assembly 120 where it is unlikely to create a tripping hazard. However, the antenna assembly 120 can be positioned anywhere on the railing, which can vary depending on the number and size of the railings in any given seating section. If possible, the antenna assembly 120 should be centered with respect to the seats 150 of the intended coverage area adjacent the railing to maximize coverage. The design of the antenna and its position with respect to railing creates a robust antenna that limits the potential for damage to the antenna or injury to any attendee.

It is further noted that the invention is described for attachment to a hand rail or safety rail. However, the housing can be configured to attach to other fixtures that are provided at a venue, within the spirit and scope of the invention. For example, the low profile of the antenna and housing enable attachment directly to concrete walls that may be distributed throughout the venue without creating an obstruction. This would require minimal reconfiguration of the housing and eliminate the need for grooves in the housing. In addition, while the housing in the preferred embodiment has two grooves to attach to the railing in two places, more or fewer connections can be made to the railing. And the housing can be positioned at the upper part of the railing to attach to the top bar and/or lower bar.

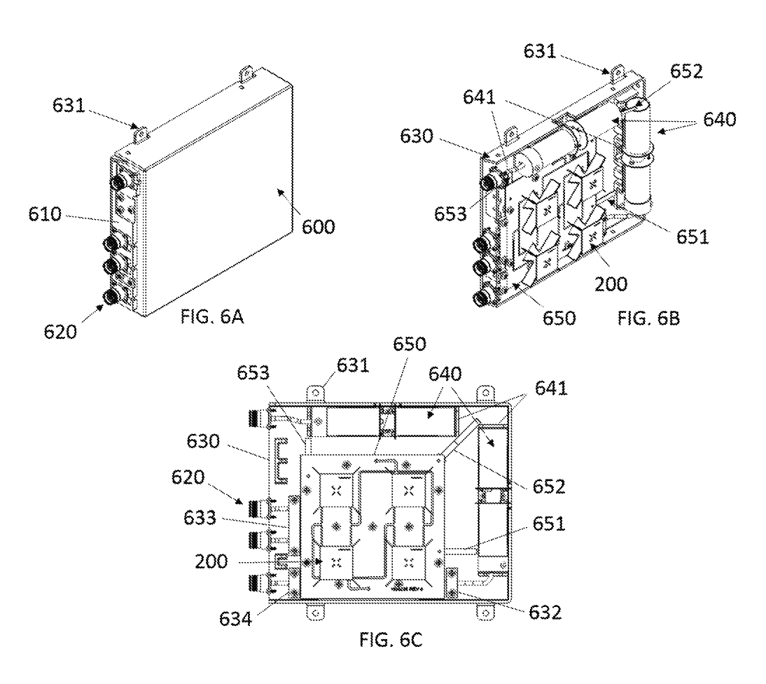

Turning to FIGS. 6A-6C, an alternative embodiment of the invention is shown. The high band RF distribution network is fully integrated into a HB feed board 650 to which the dipoles 200 are attached. The artwork to form the microstrip traces is etched on a top side of the HB feed board 650 with a nominal dielectric constant of 3.38 and loss tangent of 0.0025. The bottom side of the HB feed board 650 is predominantly covered with copper to form a HB ground plane. The HB feed board 650 is fixed in place using plastic fasteners that pass through openings in the feed board 650 and thread into protrusions in a backplane 630 that provides mounting locations and mechanical support for the antenna components.

RF signals are routed to the antenna through coaxial cables where the outer shield of the cable solders to the ground plane of the HB feed board 650, and the center pin of the cable passes through an opening in the board and is soldered to a microstrip trace on the top side of the HB feed board 650. The HB and LB coaxial connectors 620 are fixed to a connector mount 610 that provides mechanical support for the coaxial connectors 620. The connector mount 610 is made of plastic material where the dielectric constant of the plastic is nominally less than 4, and the loss tangent is nominally less than 0.01. The backplane 630 also includes cable management pieces 632, 633, 634 to assist with proper and repeatable cable routing. The purpose of the cable management pieces 632, 633, and 634 is to route the RF coaxial cables underneath the HB feed board 650 to ensure that the cables do not rub on the edge of the feed board. The backplane also includes tabs 631 with holes for mounting the backplane to the plastic housing 500.

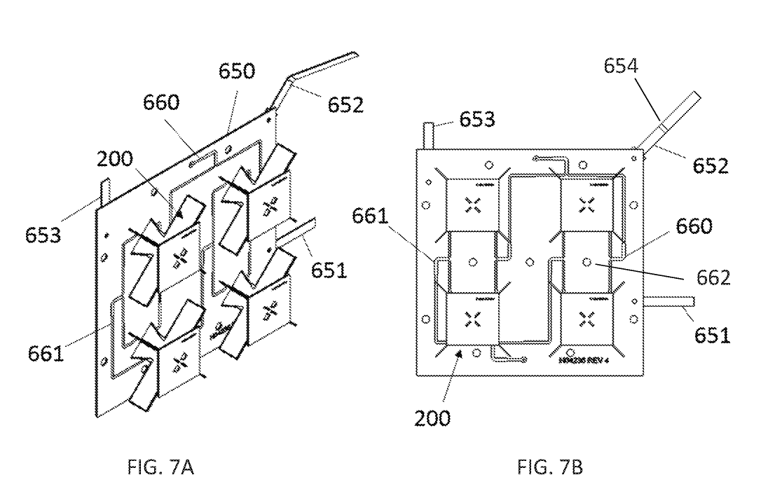

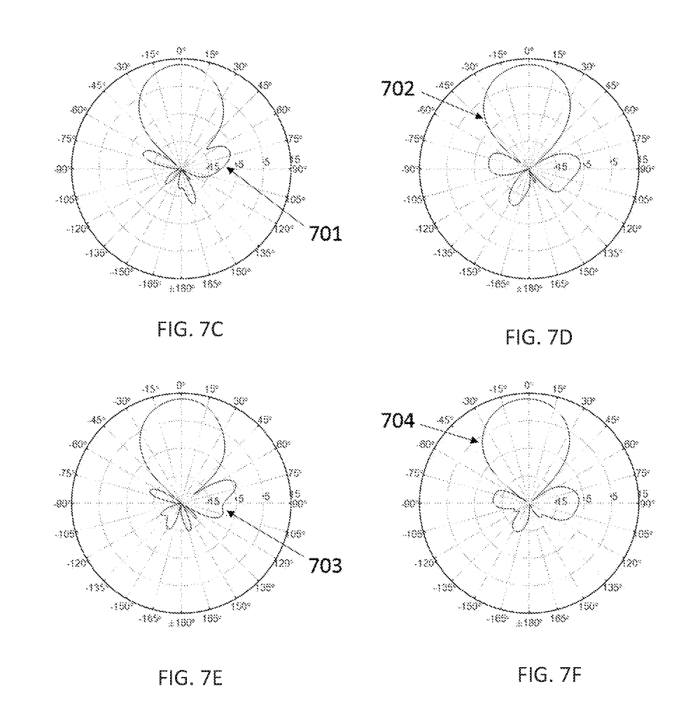

With respect to FIG. 7A, the HB feed board 650 is shown in an isometric view (view (1)) and a front view (view (2)) to illustrate the routing the of the microstrip traces to the HB elements 200. The feed network consists of a p45 trace 661 to route signals for the +45° polarization and an m45 trace 660 to route signals for the −45° polarization. The p45 trace 661 is soldered to the baluns 330b for the +45° dipoles, and the m45 trace 660 is soldered to the baluns 330a for the −45° dipole. The HB feed board 650 also includes eleven mounting holes 662 where the HB feed board 650 is mounted to the backplane 630 with plastic fasteners. The plastic fasteners are inserted through the mounting holes 662 and thread into plastic standoffs that are attached to the backplane 630. Coupled to the ground plane of the HB feed board 650 are three isolation tabs 651, 652, 653 to assist with port-to-port isolation between the V-pol and H-pol LB elements. The isolation tabs 651, 652, 653 are made of material with a substantially high conductivity such as aluminum or copper and are either parasitically coupled or directly coupled to the ground plane of the HB feed board 650. Note that the isolation tab 652 that lies between the two LB elements 640 is bent at a 45° angle. This bend 654 enhances the isolation between the two LB elements compared to the scenario where the isolation tab 652 is not bent.

By coupling the isolation tabs 651, 652, 653 to the ground plane of the HB feed board 650, the tabs effectively act as extensions of the ground plane as those skilled in the art can appreciate. The tabs can be bonded to the bottom side (ground plane) of the HB feed board 650 with solder or conductive epoxy for direct coupling. Alternatively, the tabs may be attached to the ground plane with non-conductive epoxy or double-sided tape for parasitic coupling. The holes in the isolation tabs 651, 652, 653 and HB feed board 650 serve as a means for placement of the tabs, and a fastener can also be fixed through the holes for added mechanical support for the tabs.

The pattern performance of the HB array of FIGS. 6A-6C, 7A-7B is illustrated in FIGS. 7C-7F. The +45° elevation pattern 701 and the +45° azimuth pattern 702 are shown in FIG. 7C, and the −45° elevation pattern 703 and the −45° azimuth pattern are shown in FIG. 7D. These patterns are measured for the full antenna assembly and include a section of handrail to simulate the patterns in the stadium environment. In all plots for FIGS. 7C-7F, the railing is positioned on the left side)(−90° of the pattern.

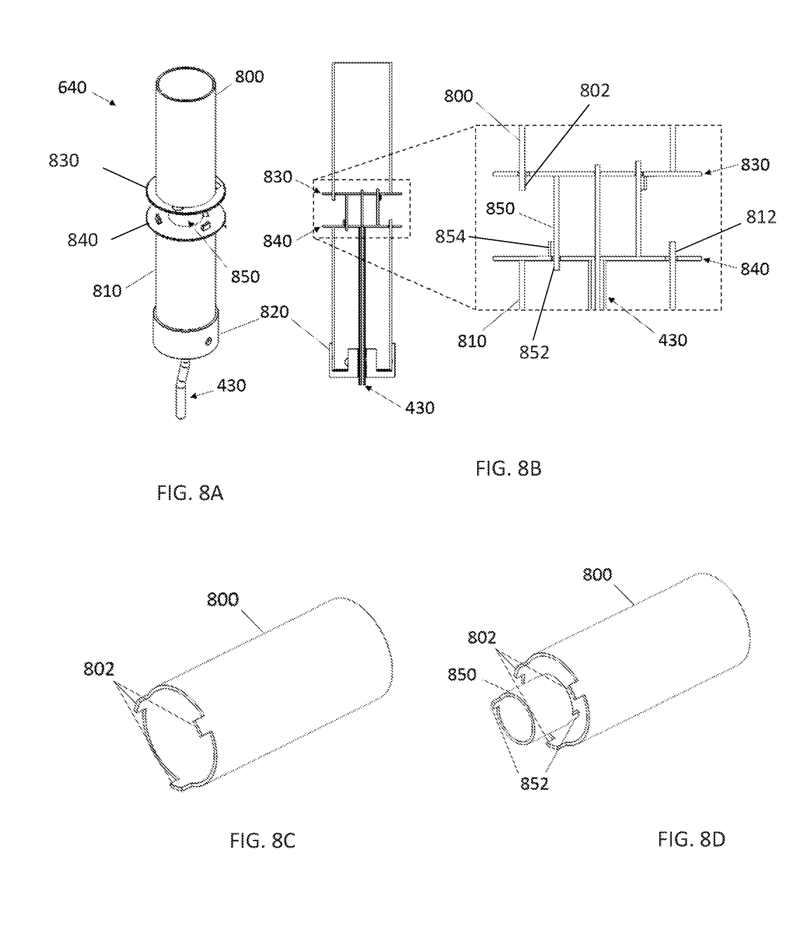

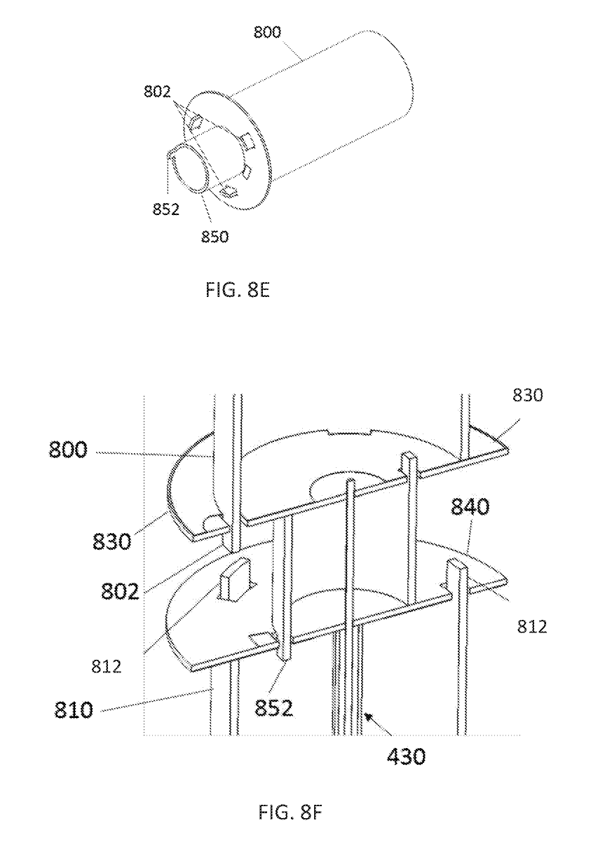

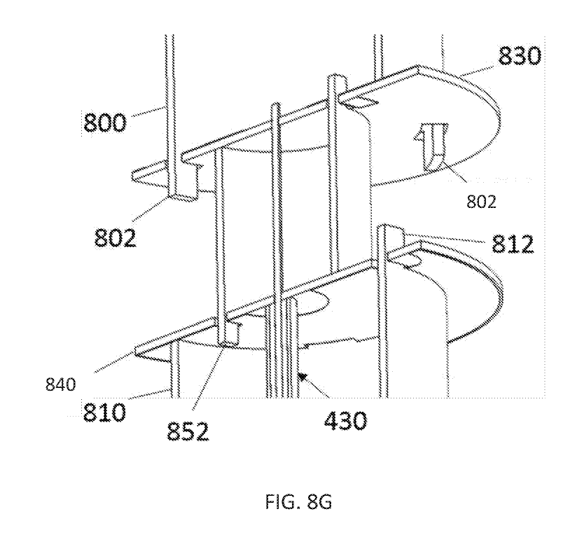

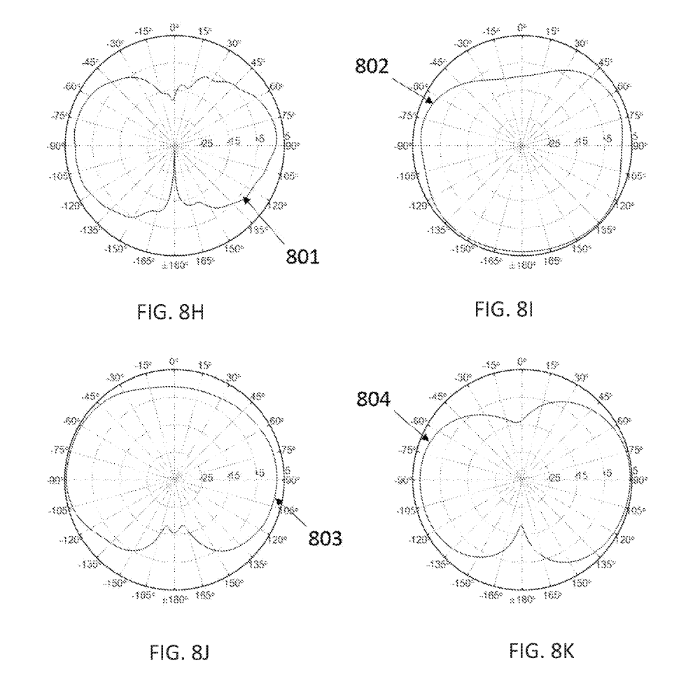

As best shown in FIG. 6C, the invention includes two LB antennas 640. The low band elements 640 may be realized in the form of dipoles fed with a coaxial cable as indicated in FIGS. 8A-8G. The LB elements 640 include a first antenna element, here an elongated cylindrical top pipe 800 and a second antenna element, here an elongated cylindrical bottom pipe 810, as well as a top printed circuit board (PCB) 830, bottom PCB 840, and tuning sleeve 850. The top PCB 830 is connected to the distal end of the top pipe 800, and the bottom PCB 840 is connected to the distal end of the bottom pipe 810. The tuning sleeve 850 has a cylindrical shape and has one end connected to the top PCB 830 and an opposite end connected to the bottom PCB 840. Both PCBs 830, 840 have a small through hole in the center for the coax center pin to pass through. It will be appreciated that any suitable omnidirectional LB element can be utilized, including the LB element shown in FIGS. 4A-4C.

The top pipe 800 has a central longitudinal axis, the bottom pipe 810 has a central longitudinal axis, and the center sleeve 850 has a central longitudinal axis. The central longitudinal axis of each the top pipe 800, the bottom pipe 810 and the sleeve 850 are aligned with each other and linear. In addition, the top pipe 800 and the bottom pipe 810 have a same width (i.e., diameter), which is larger than the width (i.e., diameter) of the sleeve 850. Thus, the top and bottom pipes 800, 810 are aligned with one another and the sleeve 850 is concentrically arranged with respect to the top and bottom pipes 800, 810, and the top pipe 800, sleeve 850 and bottom pipe 810 are aligned end to end with the sleeve 850 connecting the top pipe 800 to the bottom pipe 810 and positioned therebetween.

The sleeve 850 has a first end and a second end opposite the first end. The first sleeve end directly attaches to the top board 830, which in turn is directly attached at the distal end of the top pipe 800. Thus, the distal end of the top pipe 800 forms a closed end that is closed by the top board 830. And the second sleeve end directly attaches to the bottom board 840, which in turn is directly attached at the distal end of the bottom pipe 810. Thus, the distal end of the bottom pipe 810 forms a closed end that is closed by the bottom board 840. As shown, the top board 830 can be at the extreme distal end of the top pipe 800, with the tabs 802 of the top pipe 800 extending through openings in the board 830 and soldered thereto. And the bottom board 840 can be at the extreme distal end of the bottom pipe 810, with the tabs 812 of the bottom pipe 810 extending through openings in the bottom board 840 and soldered thereto. The tabs 852 of the sleeve 850 are received in openings in the top and bottom boards 830, 840 and are soldered thereto.

The top and bottom pipes 800, 810 partially form the dipole where the pipe material has substantially high conductivity such as aluminum or copper. Each pipe includes three tabs 802, 812 that project outward from the distal end of the pipe. The tabs 802, 812 pass through respective openings in a top LB PCB 830 and a bottom LB PCB 840. These tabs serve as alignment holes for the joining of the top and bottom pipes 800, 810 and the top and bottom LB PCBs 830, 840. The top LB PCB 830 and bottom LB PCB 840 are constructed of double-sided copper clad PCB material where most of the metal is etched away from a top side of the bottom LB PCB 840, and a bottom side of the bottom LB PCB 840 is substantially covered with copper. The only metallization on the top side of the bottom LB PCB 840 is used to solder the LB tuning sleeve 850 to the top side of the bottom LB PCB 840.

The metallization and holes in the top LB PCB 830 and bottom LB PCB 840 are identical, but for assembly, the top LB PCB 830 is flipped upside down. Therefore, the top side of the top LB PCB 830 is identical to the bottom of the bottom LB PCB 840, and the bottom side of the top LB PCB 830 is identical to the top side of the bottom LB PCB 840. The two PCBs are also rotated 180° with respect to one another to align the holes for the tabs 852 on the LB tuning sleeve 850. The tabs 852 are small members that extend outward slightly from the distal edges at each end of the sleeve 850, and connect the sleeve 850 to the top and bottom PCBs 830, 840.

The LB tuning sleeve 850 is soldered to the metallization that remains on the top side of the bottom LB PCB 840 and to the metallization that remains on the bottom side of the top LB PCB 830. The LB tuning sleeve 850 is not soldered to the metallization on the bottom side of the bottom LB PCB 840 or the metallization on the top side of the top LB PCB 830. The purpose of the LB tuning sleeve 850 is to assist in impedance matching the dipole. The height and diameter of the LB tuning sleeve can be adjusted to tune the match.

The top pipe 800 is soldered to the top side of the top LB PCB 830, and the bottom pipe 810 is soldered to the bottom side of the bottom LB PCB 840. Since the bottom side of the bottom LB PCB 840 and the top side of the top LB PCB 830 are predominantly covered in copper, the joining of the top LB PCB 830 and the top pipe 800 effectively form a top can. Similarly, the joining of the bottom LB PCB 840 and the bottom pipe 810 effectively form a bottom can. Note that the diameter and height of the top and bottom pipes 800, 810 can be adjusted for tuning the dipole.

In one example embodiment, the dimensions for the pipes are 1.25″ outer diameter for both pipes with a 0.04″ wall thickness. The top pipe 800 is 2.75″ long from the top of the top LB PCB 830. The bottom pipe 810 is 3″ long from the bottom of the bottom LB PCB 840. The tabs on both pipes are 0.15″ long. The LB tuning sleeve 850 is 0.75″ in diameter and 0.5″ in length. The diameter of the LB tuning sleeve 850 is smaller than the diameters of the pipes 800, 810. However, the purpose of the sleeve is the same where the LB tuning sleeve 850 modifies the capacitance between the top pipe 800 and bottom pipe 810 and thereby allows the impedance of the element to be tuned. Furthermore, by implementing the LB tuning sleeve 850 with a diameter smaller than the pipe diameter, the tuning sleeve acts as a spacer between top LB PCB 830 and the bottom LB PCB 840. The values listed for this element are nominal and should not vary by more than 10%. In addition, while the antenna elements 800, 810 and sleeve 850 are shown and described as being circular, they can be any suitable shape.

The outer shield of the coaxial cable 430 is soldered to the bottom side of the bottom LB PCB 840. The center pin of the coaxial cable 430 passes through a small opening in the middle of the bottom LB PCB 840 and solders to the top side of the top LB PCB 830 after passing through an opening in the middle of the top LB PCB 830. A cable guide 820 is attached to the bottom metallic pipe 810 by inserting a push rivet through openings in the cable guide 820 and the bottom metallic pipe 810. The cable guide 820 includes a curved opening that allows the cable to make a bend as it enters through the cable guide 820. The cable guide 820 should be non-metallic and made of some plastic such as ABS or Delrin with a dielectric constant below 4 and a loss tangent below 0.01. The cable guide should be slid over the cable before it is attached to the bottom LB PCB 840.

The LB elements 640 are placed on a LB carriers 641 that is attached to the backplane 630 with plastic fasteners. To hold the LB element 640 in place, tie wraps or zip ties may be used. The tie wraps pass through channels in the LB carrier 641 and around the LB element 640. The LB carrier 641 also includes tabs for positioning the LB element 640 in the LB carrier 641.

Returning to FIG. 6C, one LB element 640 is located at the side of the feed board 650, and another LB element 640 is at the top of the feed board 650. The LB elements 640 are arranged in this manner to give orthogonal vertical and horizontal polarizations establishing polarization diversity and enabling MIMO performance (this is also true for the LB elements 210 in FIG. 2). For MIMO to work, the two orthogonally polarized elements should be decorrelated, or isolated, from one another with an insertion loss of −20 dB or more between the antennas. This means that only 1% of the energy put into one antenna couples to the other antenna, and the two are isolated. The isolation tabs 651, 652, 653 assist with isolation between the two LB elements 640. The desired radiation for the LB element to the top of the HB feed board 650 has its electric field oriented horizontally, and the desired radiation for the LB element to the side of the HB feed board 650 has its electric field oriented vertically. Note that if the LB elements 210, 640 were oriented in the same direction so that their polarizations were non-orthogonal and the antennas were co-polarized, the elements would need to be spaced apart by some distance to achieve isolation between the ports. In this situation, the overall size of the antenna would increase dramatically as the required separation distance is usually multiple wavelengths. Furthermore, additional isolation structures may be needed increasing cost and complexity of the antenna.

However, antennas will accept portions of an electric field that does not perfectly align with the intended polarization direction. The isolation tabs 651, 652, 653 are either in direct contact or are parasitically coupled to the ground plane of the HB feed board 650. As a result, unwanted electric fields couple to the isolation tabs 651, 652, 653 and to the ground plane of the HB feed board 650 instead of to the element, and isolation between the LB elements 640 is improved. Note that the tabs 651, 652, 653 do not touch the LB elements 640. The direction of the tabs 651, 652, 653 is also important. The tab 651 is oriented so that its longer side is horizontal and parallel to the top LB element 640. As a result, it couples energy radiated from the top LB element 640 onto the ground plane of the HB feed board 650 and away from the side LB element 640. The tab 653 is oriented so that its longer side is vertical and parallel to the side LB element 640. As a result, it couples energy radiated from the side LB element 640 onto the ground plane of the HB feed board 650 and away from the top LB element 640. The tab 652 is oriented at a 45° angle between the two LB elements 640, and as a result, it couples electric fields oriented at 45° angles between the antennas away from each other and onto the ground plane of the HB feed board. The lengths of the tabs 651, 653 are not terribly important and are limited by the space between the LB elements and HB feed board. The tab 652 should be less than approximately 4″ in length. If this tab 652 is longer, it can cause distortion in the HB patterns. The width of all tabs is approximately 0.25″ and should be kept to within approximately 20% of this length.

MIMO capability generally increases system capacity, but it also increases cost and complexity of the antennas. As a result, MIMO may not be desired in all cases. In cases where MIMO performance is not desired, the antenna can be configured for single linear polarization. In this case, one of the polarizations can be removed from the antenna to realize single linear polarization. In the LB operating range, the top LB element 640 could be removed to realize only vertical polarization in the LB. Alternatively, the side LB element 640 could be removed to realize only horizontal polarization in the LB. In the HB operating range, the +45° polarization could be removed leaving only −45° polarization. Alternatively, the −45° polarization could be removed leaving only +45° polarization. Note that these are not the only possible polarizations for the antenna, either HB or LB could be configured for vertical, horizontal, +45°, or −45° polarization.

The LB pattern performance is illustrated in FIGS. 8H-8K. The V-pol elevation pattern 801 and the V-pol azimuth pattern 702 are shown in FIGS. 8H-81, and the H-pol elevation pattern 803 and the H-pol azimuth pattern are shown in FIGS. 8J-8K. These patterns are measured for the full antenna assembly and include a section of handrail to simulate the patterns in the stadium environment. In all plots for FIGS. 8H-8K, the railing is positioned on the top side) (0° of the pattern.

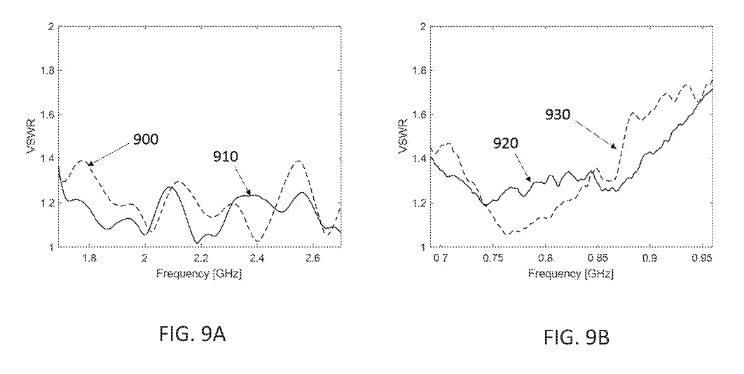

The measured voltage standing wave ratio (VSWR) for the antenna is illustrated in FIG. 9. The +45° VSWR 910 and the −45° VSWR 900 are shown in the plot of FIG. 9A. The VSWR for both polarizations is below 1.5:1 which equates to a return loss of approximately −14 dB. The V-pol VSWR 930 and H-pol VSWR 920 are shown in the plot of FIG. 9B. The VSWR for both polarizations is below 1.8:1, which equations to a return loss of approximately −11 dB.

Note that the antenna presented herein is a passive device meaning that there are no active devices such as amplifiers, transmitters, receivers, etc. located within the antenna housing 500. All of these components as required by the system are located away from the antenna. As a result, the antenna housing 500 only needs to incorporate the passive antenna components, and the size of the housing 500 can be kept to a minimum. Integrating active components as well as the LB and HB antenna structures would increase the size of the overall unit and reduce the aesthetic appeal of the present invention.

It is noted that the description uses several geometric or relational terms, such as circular, cylindrical, overlapping, parallel, perpendicular, and flat. In addition, the description uses several directional or positioning terms and the like, such as top, bottom, left, right, up, down, and distal. Those terms are merely for convenience to facilitate the description based on the embodiments shown in the figures. Those terms are not intended to limit the invention. Thus, it should be recognized that the invention can be described in other ways without those geometric, relational, directional or positioning terms. In addition, the geometric or relational terms may not be exact. For instance, walls may not be exactly perpendicular or parallel to one another but still be considered to be substantially perpendicular or parallel because of, for example, tolerances allowed in manufacturing, etc. And, other suitable geometries and relationships can be provided without departing from the spirit and scope of the invention.

Within this specification, the terms “substantially” and “about” mean plus or minus 15-20%, more preferably plus or minus 10%, even more preferably plus or minus 5%, most preferably plus or minus 1-2%. In addition, while specific dimensions, sizes and shapes may be provided in certain embodiments of the invention, those are simply to illustrate the scope of the invention and are not limiting. Thus, other dimensions, sizes and/or shapes can be utilized without departing from the spirit and scope of the invention.

The foregoing description and drawings should be considered as illustrative only of the principles of the invention. The invention may be configured in a variety of shapes and sizes and is not intended to be limited by the preferred embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

1. An antenna system for use at a venue having hand rails or safety rails, the system comprising:
a plurality of antennas distributed around the venue for wireless mobile access, and
an antenna housing configured to mount each of the plurality of antennas to one of the hand rails or safety rails.

2. The antenna system of claim 1, wherein each of the plurality of antennas are configured for one or more operating bands with a low band frequency of about 690-960 MHz and a high band frequency of about 1695-2700 MHz.

3. The antenna system of claim 1, wherein each of the plurality of antennas are configured for single linear polarization in one or more operating bands.

4. The antenna system of claim 1, wherein each of the plurality of antennas are configured for orthogonal, dual linear polarization in one or more operating bands.

5. The antenna system of claim 1, wherein each of the plurality of antennas exhibits an omnidirectional radiation pattern in one or more operating bands.

6. The antenna system of claim 1, wherein each of the plurality of antennas exhibits a directional radiation pattern in one or more operating bands.

7. The antenna system of claim 1, further comprising a radome that encloses the plurality of antennas, the radome located inside said antenna housing.

8. The antenna system of claim 1, where the antenna housing is composed of a material having a dielectric constant the range of 1-5.

9. The antenna system of claim 1, where the antenna housing further includes fasteners to fix the antenna to a hand or safety rail.

10. The antenna system of claim 1, where the plurality of antennas are connected to hand rails or safety rails.

11. The antenna system of claim 1, wherein the plurality of antennas are mounted at walkways positioned between neighboring seating sections in a stadium or arena.

12. The antenna system of claim 1, wherein the plurality of antennas each comprise an array of crossed polarized high-band elements and orthogonally polarized low-band elements arranged along an outside of the array of high-band elements.

13. The antenna of claim 1, wherein each of the plurality of antennas comprise a low band element having a first pipe with a first diameter, a second pipe with a second diameter the same as the first diameter, and a tuning sleeve having a third diameter smaller than the first and second diameters, wherein the tuning sleeve has a first end coupled to the first pipe and a second end opposite the first end and coupled to the second pipe.

14. An antenna housing comprising:
a first plate and a second plate, the first and second plates each having a top edge, bottom edge, front side edge and rear side edge, wherein the first and second plates are coupled together to retain an antenna therebetween; and
a groove formed at the top edge and at the front side edge, the groove configured to engage a hand rail or a safety rail.

15. The antenna housing of claim 14, wherein the top edges and front side edges of the first and second plates are bent inward to form the groove.

16. A low band antenna, comprising:
a first antenna element having a first width and a first distal end portion;
a second antenna element having a second width and a second distal end portion, wherein the second width is substantially the same as the first width; and
a tuning sleeve having a third width substantially smaller than the first and second widths, wherein the tuning sleeve has a first sleeve end coupled at the first distal end portion of the first antenna element and a second sleeve end opposite the first sleeve end, the second sleeve end coupled at the second distal end portion of the second antenna element.

17. The antenna of claim 16, wherein the first antenna element comprises a first pipe, the second antenna element comprises a second pipe, the first width comprises a first diameter, the second width comprises a second diameter, and the third width comprises a third diameter.

18. The antenna of claim 16, further comprising a first board directly coupled to the first distal end portion and directly coupled to the first sleeve end to couple the first distal end to the first sleeve end; and a second board directly coupled to the second distal end portion and directly coupled to the second sleeve end.

19. A dual-band antenna, comprising:
an array of crossed polarized high-band elements; and
orthogonally polarized low-band elements arranged along an outside of the array of high-band elements.
